(19) United States
(12) Patent Application Publication
(10) Pub. No.: US 2008/0057927 A1
(43) Pub. Date: Mar. 6, 2008

(54) APPARATUS AND METHOD FOR MANAGING TELEPHONE NUMBERS BASED ON CALL HISTORY IN MOBILE COMMUNICATION SYSTEM

(75) Inventor: Seung-Hwan Han, Kyeyang-gu (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/849,837

(22) Filed: Sep. 4, 2007

(30) Foreign Application Priority Data
Sep. 4, 2006 (KR) 2006-84600

(51) Int. Cl. H04M 3/42

(52) U.S. Cl. 455/415

(57) ABSTRACT

An apparatus and method for managing telephone numbers based on call history in a mobile communication system. According to the method for managing telephone number management method, a user selects a telephone number. When the user selects a memo writing or editing function for the telephone number, a memo writing or editing operation is executed for the telephone number.

### PRIORITY

This application claims priority under 35 U.S.C. § 119 to an application filed in the Korean Intellectual Property Office on Sep. 4, 2006 and assigned Serial No. 2006-84600, the contents of which are incorporated herein by reference.

### BACKGROUND OF THE INVENTION

1. Field of the Invention

The present invention generally relates to a mobile communication system, and in particular, to an apparatus and method that provides call history with additional functions using an additional database and a management program for outgoing calls, incoming calls, and/or absent calls that are stored in the call history in a mobile communication terminal.

2. Description of the Related Art

Telephone numbers that have been frequently used have normally been registered in a phonebook of a mobile communication terminal, and a phonebook function of a mobile communication terminal has become so useful that it almost replaces a memorandum book people carry with them.

In addition to a phonebook function, a mobile communication terminal is generally equipped with a call history function and a user can check a log for outgoing calls, incoming calls, and/or absent calls to figure out call history and particulars. When a telephone number to be added to the call history is already stored in the phonebook of the mobile communication terminal, the telephone number is added to the call history based on the data stored in the phonebook. When the telephone number is not stored in the phonebook, the telephone number is only stored in the call history.

In other words, a user opens the call history and figures out what number of a call is received or to what number the user makes for a call, and what call numbers the user has missed. Conventional call history functions only provide call records and do not provide any other functions based on the call history.

When a user has to make a call to a telephone number a few minutes later or at a predetermined time, or the user wants to check whether he/she is expecting a return call from a called party, the user generally registers time and details in an additional application program or a scheduler. When the time comes up and the mobile communication terminal informs the user of the details, the user should search for the telephone number in the phonebook. When the telephone number is pre-stored in the call history, the user opens the call history. This procedure requires the user to manipulate additional keys, which is annoying and may cause discomfort.

Since a conventional call history generally includes no more than simple records, as described above, the call history does not contribute to saving a number of key manipulations. Also, since no function is proved based on the call history, the telephone number may be deleted from the call history after a predetermined time when the user does not register the telephone number shown in the call history. Therefore, a need exists for an apparatus and method for managing telephone numbers based on the call history.

### SUMMARY OF THE INVENTION

The present invention substantially solves at least the above problems and/or disadvantages and provides at least the advantages below. Accordingly, an aspect of the present invention is to provide an apparatus and method for managing telephone numbers based on call history in a mobile communication system.

Another aspect of the present invention is to provide an apparatus and method that can register additional details, or memo, using a database used for managing call history in a mobile communication system.

Yet another aspect of the present invention is to provide an apparatus and method that can provide a function needed for schedule management using call history and an alarm function in a mobile communication system.

Still another aspect of the present invention is to provide an apparatus and method that can output and manage information related to an outgoing call or an incoming call in a mobile communication system.

A further aspect of the present invention is to provide an apparatus and method that manages telephone numbers based on call history to replace a main management program in a mobile communication system.

Still another aspect of the present invention is to provide an apparatus and method for effectively managing telephone numbers based on call history in a mobile communication system.

According to one aspect of the present invention, in a method for managing telephone number management method, a user selects a telephone number. When the user selects a memo writing or editing function for the telephone number, a memo writing or editing operation is executed for the telephone number.

According to another aspect of the present invention, in a method for transmitting a call using call history with a telephone number management function in a mobile communication system, when an outgoing call is made at a telephone number and the telephone number is in the call history, at least one of a memo and a to-do list is displayed for the telephone number.

According to yet another aspect of the present invention, in a method for receiving a call using call history with a telephone number management function in a mobile communication system, at least one of a memo and a to-do list is displayed for the telephone number when a call of the telephone number is received and the telephone number is in the call history.

According to still another aspect of the present invention, an apparatus for managing telephone numbers based on call history in a mobile communication system includes a controller and a call history processor. The controller registers an outgoing/incoming call in the call history and manages functions related to the call history. The call history processor writes a new memo or edits an existing memo for the telephone number of the outgoing/incoming call.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram of a mobile communication terminal according to the present invention;

FIG. 2 is a flowchart of a telephone number management process using call history according to the present invention;

FIG. 3 a flowchart of a telephone number management process when an outgoing call is made according to the present invention;

FIG. 4 a flowchart of a telephone number management process when an incoming call is received according to the present invention;

FIGS. 5A to 5G illustrate display screens when telephone numbers are managed using call history according to the present invention; and

FIGS. 6A and 6B illustrate display screens when calls are transmitted and received according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A method and apparatus for managing telephone numbers based on call history in a mobile communication system will be described below.

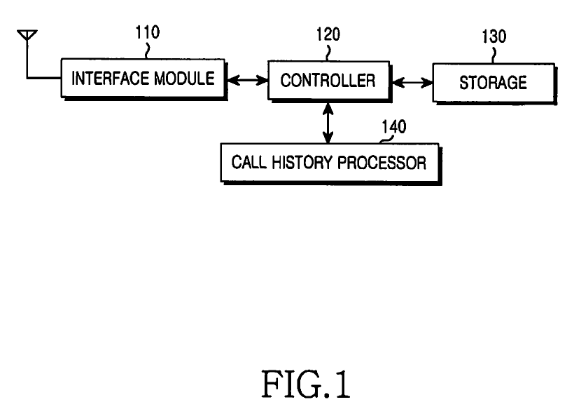

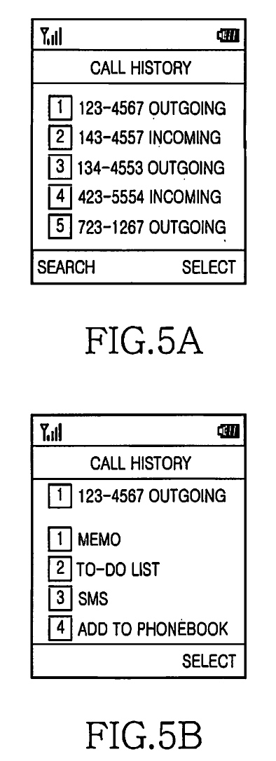

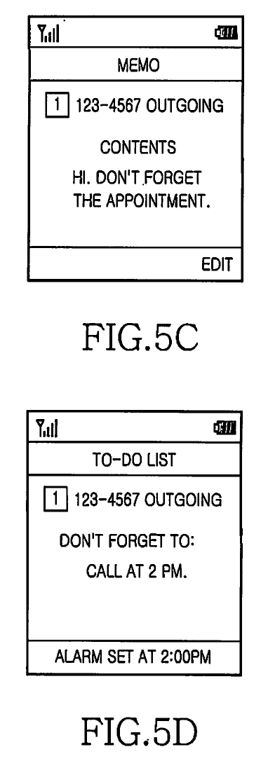

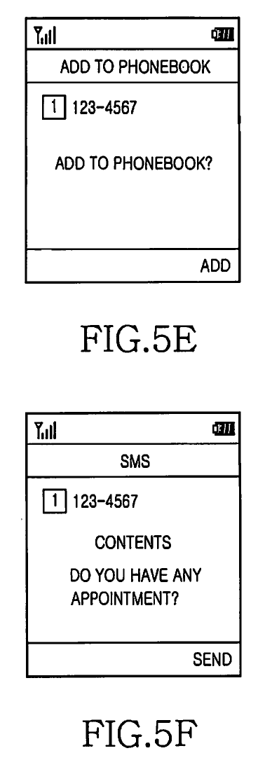

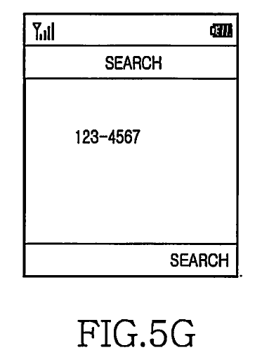

FIG. 1 shows a mobile communication terminal according to the present invention. The mobile communication terminal includes an interface module 110, a controller 120, a storage 130 and a call history processor 140. The controller 120 records transmitting or receiving calls and controls the call history processor 140 to manage telephone numbers using call history according to the present invention. For example, when a user selects a call history menu to open call history, as shown in FIG. 5A, searches telephone numbers because a telephone number is not seen and finds and selects the telephone number, or selects it without searching because the telephone number is seen, the controller 120 makes a direction to write or edit a memo for the telephone number, to make or edit a to-do list, or to write or transmit a Short Message Service (SMS) message. When the telephone number is not registered in a phonebook, the controller 120 makes a direction to inquire the user whether to add the telephone number to the phonebook. When the user responds to do so, the controller 120 makes a direction to register the telephone number in the phonebook.

The functions are displayed, as shown in FIG. 5B, and a selection is made by the user. When a call is made and the telephone number to be called is in the call history, the controller 120 makes a direction to display information for the telephone number. When the telephone number is not registered in the phonebook, the controller 120 makes a direction to inquire the user whether to register the telephone number in the phonebook and register the telephone number upon receipt of a user's selection for registration. Then, the controller 120 makes a direction to perform an operation, such as writing or editing a memo for the telephone number according to the user's decision for the operation. When an outgoing call is made and the telephone number for the outgoing call is in the call history, the controller 120 makes a direction to display information related to the telephone number.

The user can select the call history menu, search telephone numbers, or select a displayed telephone number, as shown in FIGS. 5A-5G. The user can select the call history menu to open the call history, search telephone numbers because the telephone number is not seen and find and select the telephone number, or select the telephone number without searching because the telephone number is seen. When any of these conditions occur, the call history processor 140 executes writing or editing a memo for the telephone number, writing or editing a to-do list, or writing or transmitting an SMS message based on the direction of the controller 120 and the provided information. When the telephone number is not registered in the phonebook, the call history processor 140 inquires the user whether to add the telephone number to the phonebook. When the user responds to do so, the call history processor 140 registers the telephone number in the phonebook.

The functions may be displayed, as shown in FIG. 5B, for a selection made by the user. When an incoming call is received and the telephone number of the call is in the call history, information for the telephone number is displayed. When the telephone number is not registered in the phonebook, the call history processor 140 registers the telephone number when the user decides to add the telephone number to the phonebook. When the user directs the call history processor 140 to perform a particular operation for the telephone number, such as writing or editing a memo, the call history processor 140 executes the operation. When an outgoing call is transmitted and the telephone number of the outgoing call is in the call history, information for the telephone number is displayed.

The storage 130 stores a program for controlling the general operation of the telephone number management apparatus and temporary data generated while the program is executed. In particular, the storage 130 stores information related to telephone numbers of the call history according to the present invention. In short, the storage 130 stores a database for the call history.

The interface module 110 communicates with another node and includes a Radio Frequency (RF) processor and a baseband processor. The RF processor converts signals received through an antenna into baseband signals and transmits the baseband signals to the baseband processor. The interface module 110 also converts baseband signals transmitted from the baseband processor into RF signals so they can actually be transmitted through the air, and transmits the RF signals through the antenna.

In the above described mobile communication terminal, the controller 120 may perform the functions of the call history processor 140. However, the controller 120 and the call history processor 140, as described above, are formed separately to distinctively describe the functions. However, a mobile communication terminal according to the present invention may alternatively include module(s) of various configurations with all or some of the functions of the call history processor 140 in the controller 120 described above.

The telephone number management functions based on call history are as follows according to the present invention. Referring to FIG. 5C, a user can write or edit a memo for a telephone number in the call history. The memo inputted by the user is stored in the database along with the call history, and when a call of the telephone number is received or transmitted, the stored memo is displayed. Thus, the user can see whether he/she has transmitted/received a call to/from the particular telephone number.

Referring to FIG. 5D, the user can write a simple to-do list for a telephone number. Whether the telephone number is stored in the phonebook or not is irrelevant. When the user is to transmit/receive a call again to/from the telephone number at predetermined time, or the user needs to make a call periodically, this function is very beneficial. An alarm function may be added to the to-do list through an interface with an existing alarm application program. When the predetermined time comes up and there is a memo input along with the to-do list, the memo can be displayed to inform the user at the predetermined time. Also, when a call is received or made at the telephone number, the to-do-list and the memo may be briefly displayed.

Referring to FIG. 5E, the user may simply store a telephone number in the phonebook through a menu. This function may be realized in the same sequence as an operation where, when a call whose telephone number is not stored in the phonebook is made or received, an inquiry for whether to register the telephone number in the phonebook is shown in a display.

Referring to FIG. 5F, a telephone number may be directly determined as a call receiving party for an SMS message, and a message input screen may be displayed.

Referring to FIG. 5G, a telephone number search function may be provided to the call history. It is possible to search telephone numbers for incoming/outgoing/missing calls, search some telephone numbers, and figure out how many calls have been made or received at a telephone number by loading the database.

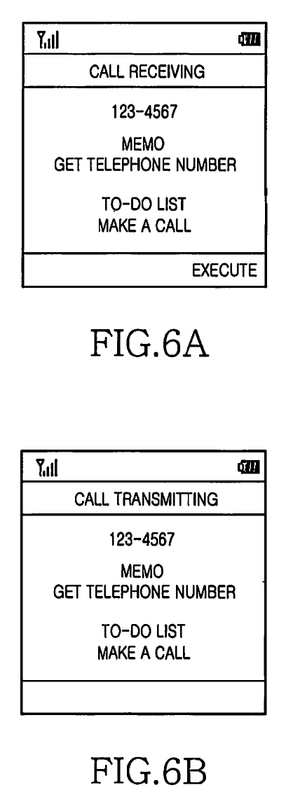

When a call is made or received and a telephone number of the call is in the call history, a memo or a to-do list related to the telephone number is displayed, as shown in FIGS. 6A and 6B. When there is such information and the telephone number is registered in the call history, the date when the telephone number is stored in the call history is displayed so the user can easily figure out whether the user receives the call of the telephone number for the first time or not.

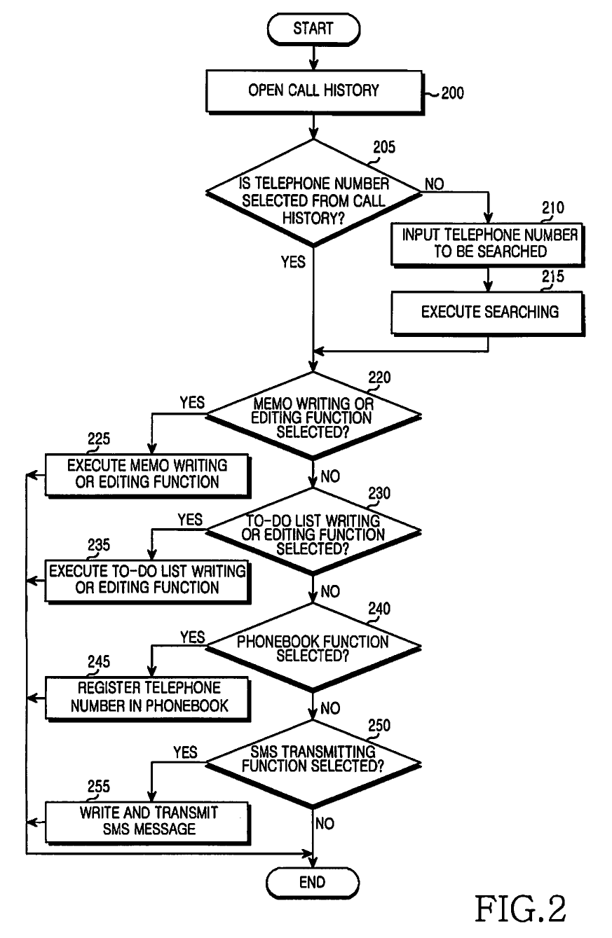

FIG. 2 shows a telephone number management process using a call history according to the present invention. When a user selects a call history menu, the controller opens the call history in step 200. When the user selects a telephone number among telephone numbers shown in the call history in step 205, the process goes to step 220.

When the user does not select a telephone number but selects a telephone number search function in step 205, the controller 120 receives a telephone number to be searched from the user in step 210, and executes searching in step 215. When the telephone number is searched successfully, the searched telephone number is selected and the process goes to step 220.

When the user selects a memo writing or editing function in step 220, the controller 120 executes the memo writing or editing function in step 225. A new memo is input or an existing memo is edited for the telephone number in the call history that is selected in step 205 or selected after search in step 215.

When the user selects a to-do list writing or editing function in step 230, the to-do list writing or editing function is executed in step 235. A new to-do list is input or an existing to-do list is edited for the telephone number in the call history that is selected in step 205 or selected after search in step 215.

When the user selects a phonebook function in step 240, the telephone number in the call history that is selected in step 205 or selected after search in step 215 is registered in the phonebook.

When the user selects an SMS writing function in step 250, the controller sets up the telephone number in the call history that is selected in step 205 or selected after search in step 215 as a call receiving part, and after the user inputs an SMS message, the interface module 110 transmits the SMS message in step 255. Then, the process ends.

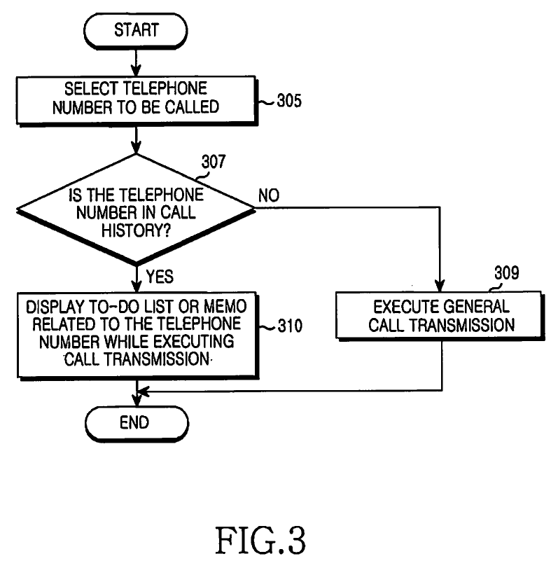

FIG. 3 shows a telephone number management process when an outgoing call is made according to the present invention. When a user makes a call by inputting a telephone number or by selecting a telephone number in step 305, the call history processor 140 checks whether the telephone number to be called is in the call history in step 307.

When the telephone number to be called is not in the call history, the call history processor 140 executes a general call transmission in step 309. When the telephone number to be called is in the call history, the call history processor 140 displays a to-do list or a memo related to the telephone number while executing the call transmission in step 310. Then, the process ends.

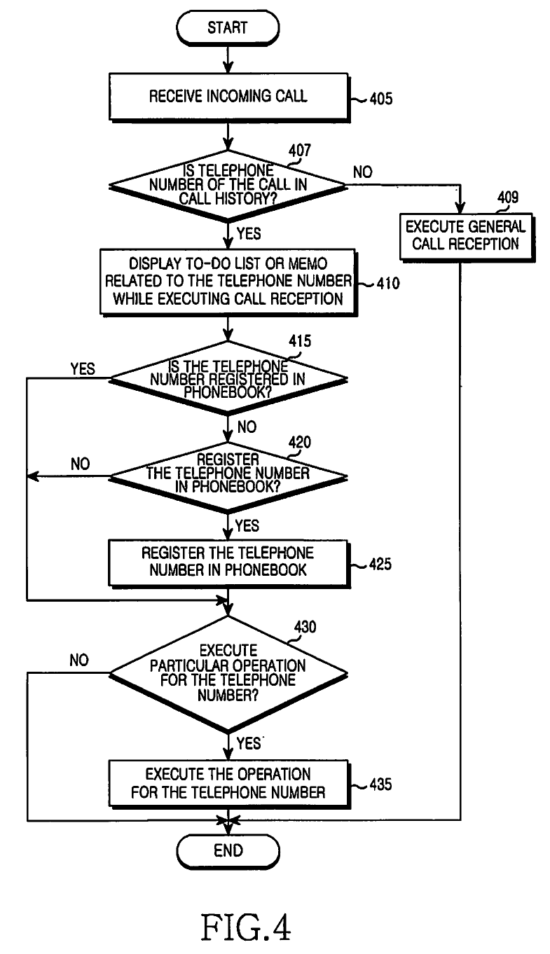

FIG. 4 shows a telephone number management process when an incoming call is received according to the present invention. When a call is received in step 405, the call history processor 140 checks whether the telephone number of the incoming call is in the call history in step 407.

When the telephone number of the incoming call is not in the call history, the call history processor 140 executes a general call reception in step 409. When the telephone number of the incoming call is in the call history, the call history processor displays a to-do list or a memo related to the telephone number of the incoming call while executing the call reception in step 410.

Subsequently, the call history processor 140 checks whether the telephone number of the incoming call is in the phonebook. When the telephone number is in the phonebook, the process goes to step 430. When step 415 indicates that the telephone number of the incoming call is not in the phonebook, the call history processor 140 inquires the user whether to register the telephone number in the phonebook in step 420.

When the telephone number is to be registered in the phonebook, the call history processor 140 registers the telephone number of the incoming call in the phonebook in step 425 and the process goes to step 430. When the telephone number is not to be registered in the phonebook, the process goes to step 430.

Subsequently, in step 430, the call history processor 140 inquires the user whether to execute a particular operation for the telephone number of the incoming call. The operation is described in the process of FIG. 2. When the user determines to do a particular operation, the call history processor 140 executes the operation at step 435. Then, the process ends.

The call history function is a call management function that a user can access most easily. All the user has to do to open the call history is just pressing a call send button once. The function is simple but it provides all call communication particulars of a mobile communication terminal. Therefore, when the user can process diverse operations in the call history without opening an application program or menu, the utility of the mobile communication terminal is enhanced.

Using the call history for diverse operations is significant because of operation sequence alterations. To be specific, in a smart phone or a Personal Digital Assistant (PDA), where each function is realized in a separate application program, individually, a corresponding application program is conventionally executed and then a desired function is executed in the application program. In contrast, the apparatus and method of the present invention makes a user comfortable in finding an application program for a desired operation by making the user select a telephone number from the call history and then direct a desired operation, which is a directly distinguishes over the conventional operation.

The present invention additionally provides a telephone number management function to a conventional call history function. Therefore, it is possible to perform an operation through a small number of key manipulations for a telephone number in the call history including telephone numbers that are not registered in the phonebook without executing a particular application program.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the present invention has been described with respect to certain preferred embodiments, it will be apparent to those skilled in the art that various changes and modifications may be made without departing from the scope of the invention as defined in the following claims.

What is claimed is:

1. A method for managing telephone numbers based on call history in a mobile communication system, the method comprising:
receiving a selection for a telephone number in a call history list from a user; and
executing one of a memo writing function and an editing operation for the telephone number in the call history list when one of the memo writing and the editing function is selected for the telephone number.

2. The method of claim 1, further comprising:
executing one of a to-do list writing function and an editing operation for the telephone number in the call history list when one of the to-do list writing function and the editing function is selected for the telephone number.

3. The method of claim 1, further comprising:
inquiring the user whether to register the telephone number in the phonebook, and registering the telephone number in the phonebook upon receipt of the selection of the user for registration when the telephone number is not in a phonebook.

4. A method for transmitting a call using call history in a mobile communication system, the method comprising:
displaying at least one of a memo and a to-do list for a telephone number when an outgoing call is made at the telephone number and the telephone number is in the call history.

5. The method of claim 4, further comprising:
inquiring a user whether to register the telephone number in a phonebook, and registering the telephone number in the phonebook upon receipt of the selection of the user for registration when the telephone number is not in the phonebook.

6. A method for receiving a call using call history in a mobile communication system, the method comprising:
displaying at least one of a memo and a to-do list for a telephone number when a call of the telephone number is received and the telephone number is in the call history.

7. The method of claim 6, further comprising:
requesting a user to perform one of write a new memo and edit an existing memo for the telephone number.

8. The method of claim 6, further comprising:
requesting a user to perform one of write a new to-do list and edit an existing to-do list for the telephone number.

9. The method of claim 6, further comprising:
inquiring a user whether to register the telephone number in a phonebook, and registering the telephone number in the phonebook upon receipt of a selection of the user for registration when the telephone number is not in the phonebook.

10. An apparatus for managing telephone numbers based on call history in a mobile communication system, the apparatus comprising:
a controller for registering an outgoing/incoming call in the call history and managing functions related to the call history; and
a call history processor for writing a memo and editing an existing memo for a telephone number of the outgoing/incoming call.

11. The apparatus of claim 10, wherein the call history processor perform one of writes a new to-do list and edits an existing to-do list for the telephone number of the outgoing/incoming call.

12. The apparatus of claim 10, wherein the call history processor displays at least one of a memo and a to-do list for the telephone number when the telephone number is selected.

13. The apparatus of claim 10, wherein the call history processor inquires a user whether to register the telephone number in the phonebook and registers the telephone number in the phonebook upon receipt of a selection of a user for registration when the telephone number is selected and the telephone number is not registered in a phonebook.

14. The apparatus of claim 10, wherein the call history processor displays at least one of a memo and a to-do list for a telephone number of an outgoing call when the outgoing call is made and the telephone number of the outgoing call is in the call history.

15. The apparatus of claim 10, wherein the call history processor inquires a user whether to register a telephone number of an outgoing call in a phonebook and registers the telephone number of the outgoing call in the phonebook upon receipt of a selection of the user for registration when the outgoing call is made and the telephone number of the outgoing call is not in the call history.

16. The apparatus of claim 10, wherein the call history processor displays at least one of a memo and a to-do list for a telephone number of an incoming call when the incoming call is received and the telephone number of the incoming call is in the call history.

17. The apparatus of claim 10, wherein the call history processor inquires a user whether to register a telephone number of an incoming call in the phonebook and registers the telephone number in the phonebook upon receipt of a selection of the user for registration when the incoming call is received and the telephone number of the incoming call is not in the call history.

18. The apparatus of claim 10, wherein the call history processor requests a user one of to write a memo and to edit an existing memo for a telephone number of an incoming call when the incoming call is received.

19. The apparatus of claim 10, wherein the call history processor requests a user one of to write a to-do list and to edit an existing to-do list for a telephone number of an incoming call when the incoming call is received.

20. A computer-readable recording medium having recorded thereon a program for managing telephone numbers based on call history in a mobile communication system, comprising;
a first code segment for receiving a selection for a telephone number from a user;
a second code segment for executing one of a memo writing function and an editing operation for the telephone number when one of the memo writing and the editing function is selected for the telephone number;
a third code segment for executing one of a to-do list writing function and an editing operation for the telephone number when one of the to-do list writing function and the editing function is selected for the telephone number; and
a fourth code segment for inquiring the user whether to register the telephone number in the phonebook, and registering the telephone number in the phonebook upon receipt of the selection of the user for registration when the telephone number is not in a phonebook.

21. An apparatus for transmitting a call using call history in a mobile communication system in combination with the recording medium of claim 20, the combination comprising:
means for displaying at least one of a memo and a to-do list for a telephone number when an outgoing call is made at the telephone number and the telephone number is in the call history; and
means for inquiring a user whether to register the telephone number in a phonebook, and registering the telephone number in the phonebook upon receipt of the selection of the user for registration when the telephone number is not in the phonebook.

22. An apparatus for receiving a call using call history in a mobile communication system in combination with the recording medium of claim 20, the combination comprising:
means for displaying at least one of a memo and a to-do list for a telephone number when a call of the telephone number is received and the telephone number is in the call history;
means for requesting a user to perform one of write a new memo and edit an existing memo for the telephone number;
means for requesting a user to perform one of write a new to-do list and edit an existing to-do list for the telephone number and;
means for inquiring a user whether to register the telephone number in a phonebook, and registering the telephone number in the phonebook upon receipt of a selection of the user for registration when the telephone number is not in the phonebook.
